(19) United States
(12) Patent Application Publication
(10) Pub. No.: US 2002/0176944 A1
(43) Pub. Date: Nov. 28, 2002

(54) Spray guns

(76) Inventor: Philip John Merrifield, Verwood (GB)

Correspondence Address: LOWE HAUPTMAN GILMAN & BERNER, LLP, Suite 310, 1700 Diagonal Road, Alexandria, VA, 22314, US

(21) Appl. No.: 10/076,139

(22) Filed: Feb. 15, 2002

(30) Foreign Application Priority Data
Feb. 16, 2001 (GB) 0103863.7

(51) Int. Cl. B05D 1/02; B43K 27/00

(52) U.S. Cl. 427/402; 401/34

(57) ABSTRACT

The invention relates to a set of two or more spray guns for use when applying two or more types of fluid coating to an article, the spray guns bearing a recognizable coding sequence indicating the sequence by which the spray guns are to be used.

This invention relates to improvements in and relating to spray guns, for example the provision of coded spray guns.

### BACKGROUND OF THE INVENTION

Articles are often coated with a combination of different types of coating. An example of such a coating is paint and examples of combinations of paints include a primer and top coat; a primer base coat and clear coat, and a primer, an intermediate coat and a top coat. Such coatings are frequently applied by spray gun.

When such coatings are applied by a single spray gun, the gun must be thoroughly cleaned between applications of each type of coating. Alternatively a plurality of spray guns may be provided, each one applying a single type of coating. Thus, for an article requiring to be coated with a primer and a top coat, two spray guns are provided, one for application of the primer and the other for application of the top coat.

It is, of course, very important to coat any article with the correct sequence of coating types. Thus, for an article requiring coating with a primer and top coat, it is clearly the primer which must be applied first followed by the top coat. It is not always clear which spray gun supplies which type of coating, and in the absence of some form of coding means indicating the sequence by which spray guns are to be used, it is quite possible for an incorrect sequence of coatings to be applied to an article. The likelihood of such a mistake will increase with the number of types of coatings to be applied to any particular article.

GB 2 085 120 A (Lurmark) relates to nozzle and check valve assemblies particularly adapted for use in agriculture and horticulture for spraying, for example, liquid fertilizer or weed inhibitor. In order to select check valves with the appropriate threshold pressure for the liquid to be sprayed, at least part of the exterior surface of the check valve which is visible to the eye is colour coded according to the pressure threshold level. Likewise in order to select the correctly sized nozzle for the liquid to be sprayed, at least part of the surface of the spray nose is coloured according to the nozzle size.

U.S. Pat. No. 4,545,534 (Schaefer) discloses an air brush organiser comprising a plurality of air brushes, each air brush delivering a different colour. The organiser includes a colour coding band which passes adjacent all the air brushes such that the portion of band passing adjacent the air brush for applying red paint is coloured red and the portion of band passing adjacent the air brush for applying blue paint is coloured blue. The colour of the coding band, as it passes each air brush reflects the colour of the paint applied by the air brush. Thus the band is coloured according to the following sequence in a clockwise direction: green; blue; purple; red; orange; and yellow.

Spray guns are known comprising a plurality of spray guns, each gun provided with a plastic coloured indicator at the bottom of the handle. Specifically the plurality of spray guns comprises four guns each with a red, green, black or blue indicator but with no two spray guns comprising indicators of the same colour.

The objective of the present invention is to provide a plurality of spray. As for use when applying more than one kind of coating to an article, the spray guns being coded to indicate a sequence by which the spray guns are to be used

### SUMMARY OF THE INVENTION

One aspect of the invention provides a set of two or more spray guns for use when applying more than one type of fluid coating to an article, the spray guns bearing a recognisable coding sequence indicating the sequence by which the spray guns are to be used.

By recognisable coding sequence is meant a group of indicia, such as letters, numbers, symbols or colours that have a sequence that is recognisable by the relevant public. Thus, for example, the group of numbers 1, 2 and 3, or the words ONE, TWO and THREE, or the group of letters A, B and C define recognisable sequences. Similarly, in those countries where traffic signals have the green-amber-red sequence, the colours green, amber (or yellow or orange) and red would constitute a sequence

In one particular embodiment, the recognisable coding sequence comprises colours or numbers or letters or words or symbols, in particular the recognisable coding sequence is a recognisable colour sequence. The preferred recognisable colour sequence consists of the colours green, amber and red.

More particularly the invention provides a set as hereinbefore defined, wherein each spray gun comprises a body, a handle attached thereto, a spray head secured to the spray gun body, a trigger for operating the spray gun, and a connector for attachment to a compressed air supply for providing atomisation and spray pattern shaping air, a member of the recognisable coding sequence being located on an upper part of each spray gun.

A particularly preferred embodiment of the invention is a set wherein each spray gun comprises a reservoir for supplying the paint or other fluid medium to be sprayed, the recognisable coding sequence being located on at least part of the reservoir. Preferably the reservoir is attached to the upper part of the body.

Typically, a set comprises a different member of the recognisable coding sequence located on the same part of each spray gun. By the term member is meant, for example, a particular colour or number or letter or word or symbo,l such as the number 1 in the number sequence 1, 2 and 3 or the colour green in the colour sequence green, amber and red, which in combination with the other members of the sequence form a recognisable coding sequence.

One embodiment of a reservoir comprises a feed cup. If the feed cup comprises a removable lid, then the recognisable coding sequence can be located on at least part of the removable lid. The feed cup can also be detachable. Furthermore the feed cup and/or the removable lid can be formed from a plastics material.

Another aspect of the invention is provided by a set of two or more spray guns wherein each spray gun comprises a body, a handle attached thereto, a spray head secured to the spray gun body, a trigger for operating the spray gun, and a connector for attachment to a compressed air supply for providing atomisation and spray pattern shaping air, a feed cup attached to the upper part of the body for supplying the fluid coating to be sprayed, the feed cup comprising a removable lid, each removable lid bearing a member of a recognisable coding sequence consisting of the colors green, amber and red indicating the sequence by which the spray guns are to be used.

The invention further comprises a set as hereinbefore defined, wherein each spray gun has a reservoir filled with a different fluid coating, each reservoir bearing a different member of the recognisable colour sequence, and wherein for at least one reservoir, the colour of the fluid coating is dissimilar to the colour of the particular member of the recognisable colour sequence borne by the said reservoir.

A further aspect of the present invention provides a set of two or more detachable feed cups suitable for use with a single spray gun or a set of spray guns as hereinbefore defined, the feed cups together bearing a recognisable coding sequence indicating the sequence by which the spray guns are to be used.

Yet another aspect of the invention is the provision of a set of two or more removable lids suitable for use with a set of two or more detachable feed cups as hereinbefore defined, the removable lids together bearing a recognisable coding sequence as hereinbefore defined.

Another aspect of the invention is a method for applying two or more types of coating to an article, using a set of two or more spray guns as hereinbefore defined, each having a reservoir or a feed cup filled with a paint or fluid medium to be sprayed, each spray gun bearing a member of the recognisable coding sequence, comprising the steps:

a. applying the paint or fluid medium to be delivered by the spray gun bearing the first member of the recognisable coding sequence,

b. applying the paint or fluid medium to be delivered by the spray gun bearing the second member of the recognisable coding sequence; and optionally,

c. applying the paint or fluid medium to be delivered by the spray gun bearing the third member of the recognisable coding sequence; and optionally thereafter for further members.

A further aspect of the present invention is the provision of a method for applying two or more types of coating to an article, using a single spray gun, and a set of detachable feed cups as hereinbefore defined, each detachable feed cup being filled with a paint or fluid medium to be sprayed, comprising the steps:

d. attaching the detachable feed cup bearing the first member of the recognisable coding sequence to the spray gun and applying the paint or fluid medium to be delivered by the spray gun;

e. attaching the detachable feed cup bearing the second member of the recognisable coding sequence to the spray gun and applying the paint or fluid medium to be delivered by the spray gun; and optionally,

f. attaching the detachable feed cup bearing the third member of the recognisable coding sequence to the spray gun and applying the paint or fluid medium to be delivered by the spray gun; and optionally thereafter for further members.

### BRIEF DESCRIPTION OF THE DRAWING

FIG. 1 is a plan view of a spray gun facing to the left fitted with a gravity feed cup.

### DETAILED DESCRIPTION OF THE PREFERRED EMBODIMENT

The invention will be understood in greater detail from the following description of a preferred embodiment thereof given by way of example only and with reference to the accompanying drawing.

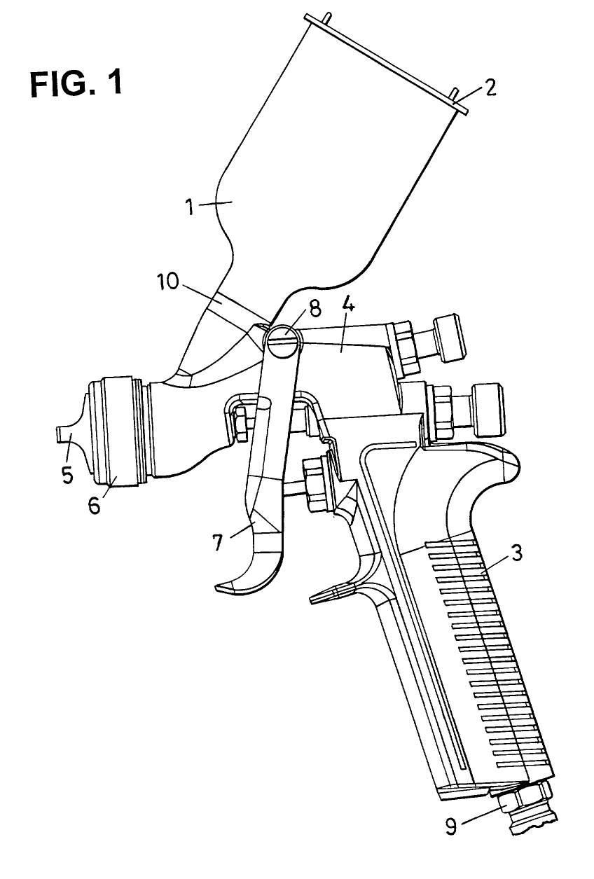

Referring now to FIG. 1 of the drawings, the spray gun has a body 4 having an integral handle 3 pendant from one end of the spray gun, and a spray head 5 secured to the opposite end of the spray gun by a retaining ring 6. A trigger 7 is secured to the body 4 by a screw 8 to pivot towards the handle 3 when manually squeezed to turn on the spray gun A compressed air hose (not shown) can be attached to a connector 9 located at the free end of handle 3. Compressed air from the hose is supplied through passages within the spray gun to provide atomisation and spray pattern shaping air to the air cap 5. Paint or other fluid medium to be sprayed enters the spray gun through a threaded bore 10 and is supplied to the fluid discharge orifice, located in the spray head, via internal passageways within the spray gun. A gravity feed cup 1 is attached to the bore 10 via a screw fit. The gravity feed cup 1 is provided with a lid 2, both constructed from plastics material such as polycarbonate, polyethylene and polypropylene. Additionally the lid is coloured one of either red, yellow or green.

Typically a set of three spray guns are used together, each set comprising spray guns identical in all respects except that the lids 2 of each of the gravity feed cups are coloured according to the recognisable coding sequence red, amber and green.

Each of the gravity feed cups 1 are filled with a different type of fluid to be sprayed. For example, if the spray gun operator intends to spray an article with a primer, a base coat and a top coat, then each of the gravity feed cups 1 will be filled with either the primer, base coat or top coat with the proviso that no two spray guns will apply the same coating.

The choice of coating to be sprayed from each spray gun is dependent on its position within its spraying sequence. Thus the spray gun with the green lid 2 will spray the primer as this is the first coating to be applied to the article. The spray gun with the amber lid 2 will spray the base coat onto the article as this is the next coating to be applied in the sequence. Lastly the spray gun with the red lid 2 will spray the top coat as this is the final coating to be applied to the article. Thus the sequence of spraying follows the recognised coding sequence of green, amber and red.

The invention is not limited by or to the specific embodiment described therein but can undergo considerable variation without departing form the scope of the invention. In particular, it should be appreciated that the invention may be adapted to various known types of spray guns including both high pressure air atomisation and low volume low pressure (HVLP) spray guns and spray guns having either suction fluid feed or gravity fluid feed or pressure feed or a combination of types of fluid feed.

1. A set of two or more spray guns for use when applying two or more types of fluid coating to an article, the spray guns bearing a recognisable coding sequence indicating the sequence by which the spray guns are to be used.

2. A set according to claim 1 wherein the spray guns bear a recognisable coding sequence comprising colours or numbers or letters or words or symbols.

3. A set according to claim 2 wherein the recognisable coding sequence is a recognisable colour sequence.

4. A set according to claim 3 wherein the recognisable colour sequence consists of the colours green, amber and red.

5. A set according to any one of the preceding claims wherein each spray gun comprises a body, a handle attached thereto, a spray head secured to the spray gun body, a trigger for operating the spray gun, and a connector for attachment to a compressed air supply for providing atomisation and spray pattern shaping air, a member of the recognisable coding sequence being located on an upper part of each spray gun.

6. A set according to any one of the preceding claims wherein each spray gun comprises a reservoir for supplying the fluid coating to be sprayed, a member of the recognisable coding sequence being located on at least part of each reservoir.

7. A set according to claim 6 wherein the reservoir is attached to the upper part of the body.

8. A set according to claim 6 or claim 7 wherein the reservoir comprises a feed cup.

9. A set according to claim 8 wherein the feed cup comprises a removable lid.

10. A set according to claim 9 wherein the recognisable coding sequence is located on at least part of the removable lid.

11. A set of two or more spray guns wherein each spray gun comprises a body, a handle attached thereto, a spray head secured to the spray gnu body, a trigger for operating the spray gun, and a connector for attachment to a compressed air supply for providing atomisation and spray pattern shaping air, a feed up attached to the upper part of the body for supplying the fluid coating to be sprayed, the feed cup comprising a removable lid, each removable lid bearing a member of a recognisable coding sequence consisting of the colours green, amber and red indicating the sequence by which the spray guns are to be used.

12. A set according to any one of claims 8 to 11 wherein the feed cup is detachable.

13. A set according to any one of claims 8 to 12 wherein the feed cup and/or the removable lid is/are formed from a plastics material.

14. A set according to claim 3 or any claim dependent thereon, wherein each spray gun has a reservoir filled with a different fluid coating, each reservoir bearing a different member of the recognisable colour sequence, and wherein for at least one reservoir, the colour of the fluid coating is dissimilar to the colour of the particular member of the recognisable colour sequence borne by the said reservoir.

15. A set of two or more detachable feed cups suitable for use with a single spray gun or a set of spray guns as defined in any one of the preceding claims, the feed cups together beg a recognisable coding sequence as defined in any one of the preceding claims.

16. A set of two or more removable lids suitable for use with a set as defined in claim 15, the removable lids together bearing a recognisable coding sequence as defined in any one of the preceding claims.

17. A method for applying two or more types of coating to an article, using a set of two or more spray guns as defined in claims 1 to 14, each having a reservoir or a feed cup filled with a paint or fluid medium to be sprayed, each spray gun bearing a member of the recognisable coding sequence, comprising the steps:
a) applying the paint or fluid medium to be delivered by the spray gun bearing the first member of the recognisable coding sequence;
b) applying the paint or fluid medium to be delivered by the spray gun bearing the second member of the recognisable coding sequence; and optionally,
c) applying the paint or fluid medium to be delivered by the spray gun bearing the third member of the recognisable coding sequence; and optionally thereafter for further members.

18. A method for applying two or more types of coating to an article, using a single spray gun, and a set of detachable feed cups according to claim 15, each detachable feed cup being filled with a paint or fluid medium to be sprayed, comprising the steps:
a) attaching the detachable feed cup bearing the first member of the recognisable coding sequence to the spray gun and applying the paint or fluid medium to be delivered by the spray gun;
b) attaching the detachable feed cup bearing the second member of the recognisable coding sequence to the spray gun and applying the paint or fluid medium to be delivered by the spray gun; and optionally,
c) attaching the detachable feed cup bearing the third member of the recognisable coding sequence to the spray gun and applying the paint or fluid medium to be delivered by the spray gun, and optionally thereafter for further members.

19. A set of two or more of spray guns substantially as described with reference to the description, drawings and claims.

20. A set of two or more detachable feed cups substantially as described with reference to the description, drawings and claims.

21. A set of two or more removable lids substantially as described with reference to the descriptions drawings and claims.
